(19) United States
(12) Patent Application Publication
(10) Pub. No.: US 2019/0005249 A1
(43) Pub. Date: Jan. 3, 2019

(54) ASSURED COMPUTER ARCHITECTURE -VOLATILE MEMORY DESIGN AND OPERATION

(71) Applicant: Riverside Research Institute, New York, NY (US)

(72) Inventor: Rusty Baldwin, Huber Heights, OH (US)

(73) Assignee: Riverside Research Institute, New York, NY (US)

(21) Appl. No.: 16/101,965

(22) Filed: Aug. 13, 2018

Related U.S. Application Data
(62) Division of application No. 15/262,550, filed on Sep. 12, 2016.
(60) Provisional application No. 62/218,092, filed on Sep. 14, 2015.

(51) Int. Cl. G06F 21/60; H04L 9/32; G06F 21/57; G06F 21/85

(52) U.S. Cl. CPC G06F 21/602; H04L 9/3234; G06F 2221/2153; G06F 21/85; G06F 21/575

(57) ABSTRACT

A method and apparatus providing computer system cryptographic protection including a processor, a trusted platform module, trusted bus devices, a first secure memory and a second secure memory, wherein the first and second memory each have a first and second shadow copy, an external bus controller, and a system bus. The system bus contains trusted data and connects with the processor, the trusted platform module, trusted bus devices, the first and second secure memory and the external bus controller. The first and second secure memory separating code and data via physically distinct memory components. The contents of the distinct memory components being replicated into two shadow copies for each component, wherein during a write operation, simultaneously updating the shadow copies with the contents of the distinct components, and during a read operation, sending the two shadow copies and the memory component to a majority function.

This application is a divisional of U.S. patent application Ser. No. 15/262,550, filed on Sep. 12, 2016, entitled “Assured Computer Architecture—Volatile Memory design and Operation,” which claims priority to U.S. Provisional Patent Application No. 62/218,092 filed Sep. 14, 2015, entitled “Assured Computer Architecture”, which are hereby incorporated by reference in their entirety.

The present invention relates generally to computing systems, more particularly to a computer architecture having cryptographic protection.

### BACKGROUND OF THE INVENTION

Cryptographic protection schemes are among the most difficult to crack and provide some of the best security against data exploitation the security community knows how to engineer. It is estimated that a 10 Pentaflop supercomputer would require more than a quintillion (1.02×10¹⁸) years to crack 128-bit AES protected data via a brute force attack. The following techniques for data protection and security are known.

In U.S. Pat. No. 7,082,539, Kitahara teaches an information processing apparatus having a CPU that includes a microprocessor, a cryptographic processing algorithm ROM, a cryptographic processing hardware circuit, a RAM, a key custody area, and an external bus controller integrated on a single chip. The encryption/decryption processing, therefore is carried out only in the CPU, and internal operations of the CPU are non-analyzable from an external signal of the CPU.

In U.S. Pat. No. 7,386,890, Galal teaches a method and apparatus of preserving a hash value of an executable module. A header in the module includes a start and end address for the dynamic data area. The executable data is loaded into a memory. An alternate memory area is allocated in the memory. The dynamic data area is copied to the alternate memory area. Both the dynamic data and the alternate memory area are mapped as separately available memory areas to the process that performs the copy operation. The virtual memory is then mapped so that execution of the executable module modifies exactly one of the dynamic area and the alternate memory area in the physical memory. Thus, only one of the two areas is left unchanged by the execution. A hash value is computed.

In U.S. Patent Publication No. 2014/0223569, Gail teaches an embedded security module relating to system on chip designs that includes a security processor, volatile and non-volatile memory and an interface. The volatile memory stores data and code that is accessed by the security processor.

In U.S. Pat. No. 9,002,014, Henry teaches a microprocessor that provides a secure execution mode of operation that allows code to be executed in a highly secure environment within the microprocessor.

### SUMMARY OF THE INVENTION

An objective of the present invention is to provide a computer architecture having an attack surface with comparable difficulty to the current cryptographic protection schemes.

The Assured Computer Architecture, ACA, provides proactive cyber defense capabilities and modifies the domain in favor of mission assurance. The mission is positioned orthogonal to the threat by forcing all threats into the cryptographic domain. The ACA provides a resilient, robust, and flexible platform for mission success.

An object of the present invention is to provide a method for cryptographically protecting a computer system, the method including the following steps: encrypting data, except when the data is in use; connecting trusted devices to a system bus; separating code and data via physically distinct memory components; replicating the contents of the distinct memory components into two shadow copies for each component, wherein during a write operation, simultaneously updating the shadow copies with the contents of the distinct components, and during a read operation, sending the two shadow copies and the memory component to a majority function.

An object of the present invention is to provide an apparatus providing computer system cryptographic protection including: a processor; a trusted platform module; trusted bus devices; a first secure memory and a second secure memory, wherein the first and second memory each have a first and second shadow copy; an external bus controller; and a system bus.

### BRIEF DESCRIPTION OF THE DRAWINGS

This invention may be understood by reference to the following description taken in conjunction with the accompanying drawings, in which like reference numerals identify similar elements, and in which:

FIG. 1 illustrates a logical view of the Assured Computer Architecture Design; and

FIG. 2 illustrates a logical view of the Volatile Memory Block Diagram View

### DETAILED DESCRIPTION

The ACA cryptographically secures data at rest, data in use, and data in motion, as well as ensuing data segregation among processes. This approach places threats orthogonal to the mission by forcing an attacker to defeat multiple cryptographically-hard protection schemes prior to discovering vulnerability or attempting to exploit. This exposes a single plausible attack surface—a cryptographically hard one.

The ACA is designed for embedded systems but may also be used as a basis for a commodity architecture as well. The present invention ACA, described below, proactively protects systems via a specialized security-focused design, trusted hardware, a hardware operating system (OS), program code integrity mechanisms, and robust resiliency techniques. External devices are not trusted and the system bus itself is assumed to be monitored.

The hallmark of ACA is that data is encrypted except when in use. This implements a key secure design principle of fail-safe defaults and protects any data that may be exfiltrated through sophisticated side-channel or cold boot attacks. Furthermore, it renders code injection attacks infeasible.

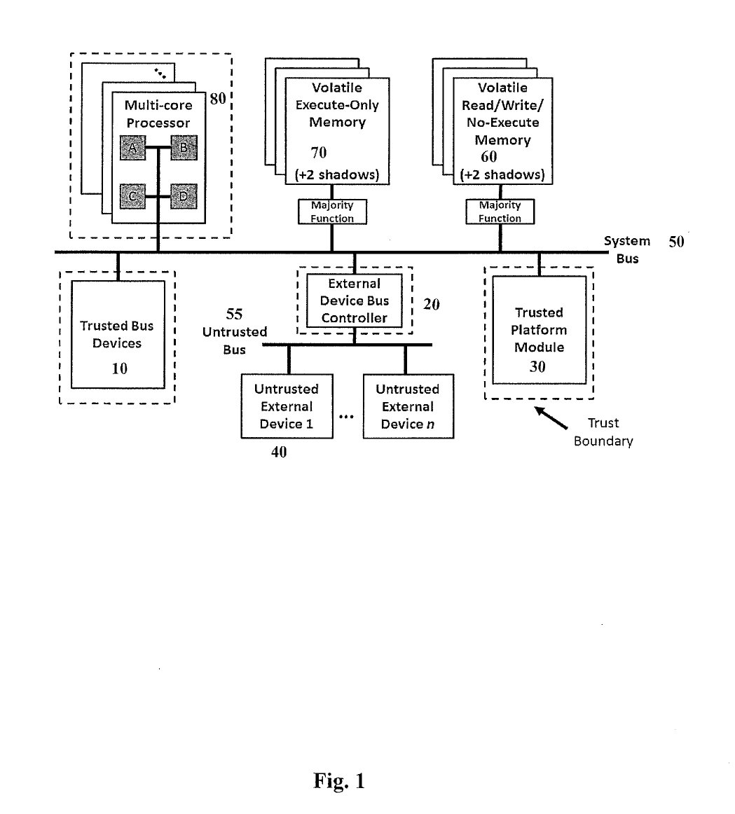

FIG. 1 is a logical view of the ACA. System bus line 50 connects with the different components within the architecture including trusted bus devices 10, external bus controller 20, Trusted Platform Module (“TPM”) 30, multi-core processor 80, and two volatile memories 60, 70 with their respective two shadows. Volatile memory 60, 70 connects to system bus 50 via a majority function 150. The dashed lines in FIG. 1 represent trust boundaries within the architecture. Multi-core processor 80, trusted bus devices 10, external bus controller 20 and TPM 30 each have trust boundaries. Within these trust boundaries data can be unencrypted as needed but often remains encrypted even therein. The root of trust is provided by a (perhaps integrated) TPM 30 whose services include secure key generation, secure key storage, and certified and secure multi-stage boot services. A trusted device 10 is one that is compliant with TPM 30 and whose configuration has been verified during the secure boot process. Symmetric keys (used for high-speed encryption/decryption during post boot operations) are generated, encrypted and sent to trusted devices 10 via a public key infrastructure (PKI) scheme as part of the secure boot process.

External device bus controller 20 provides secure arbitration and data transfer with any external devices 40a-n, which by default are untrusted. Untrusted external devices 40a-n are connected to external bus controller 20 via an untrusted bus 55. Untrusted external devices 40a-n are not allowed direct access to system bus 50 thus precluding direct bus monitoring as well as segregating untrusted data from main system bus 50. Trusted bus devices 10 and TPM 30 are connected to system bus 50. Strict code and data separation is enforced via physically distinct volatile memory components 60, 70. The data is separated by data at rest, data in use and data in motion. Volatile memory is protected by both hardware and OS mechanisms that ensure the volatile execute-only memory 70 is non-writable except during program loading/swapping operations which are defined by a trusted loader and that no code is executed from volatile read/write/no-execute memory 60. Other protections provided by these components are discussed below. Multi-core processor(s) 80 provides general computation services and all trusted components include high-speed symmetric encryption/decryption engines. Code and data for each processor are encrypted with processor specific keys to ensure data confidentiality among processors.

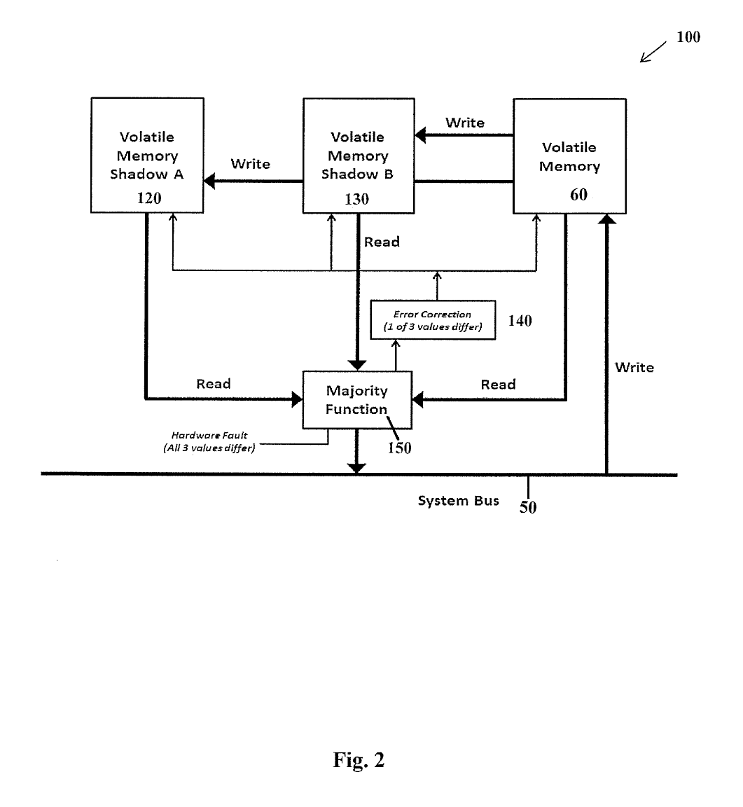

Data at rest in trusted devices is encrypted using keys supplied via TPM 30. In addition, a triple modular redundancy scheme further protects data at rest in the two volatile memory components, Volatile Execute Only Memory 70 and Volatile Read/Write/No-Execute Memory 60. FIG. 2 discloses a logical block diagram of the volatile memory design 100. Each volatile memory component 60, 70 includes two shadow copies, shadow A 120 and shadow B 130. (Volatile memory 60 is shown in FIG. 2 and discussed below as an example, however the same applies for volatile memory 70). These shadow copies are exact replicas of their volatile memory 60 contents. Volatile memory shadow copies 120, 130 are in separate and distinct memory spaces which are neither accessible nor addressable from system bus 50. During a write operation, data is written from system bus 50 to volatile memory 60. At this time, shadow memory 120, 130 are updated simultaneously with the main volatile memory 60. During a read operation, the two shadows 120, 130 and the one “main” copy 60 of the requested memory location(s) are sent to majority function 150.

Majority function 150 compares the two shadows, 120 and 130, and the main memory 60. If identical, one of volatile memory 60 and the two volatile memory shadows 120, 130 is randomly selected via logic embedded in majority function 150 and forwarded to the requesting component via system bus 50.

If only two of the volatile memory 60 and the volatile memory shadows 120, 130 are the same, it is presumed that the differing value is faulty and one of the two remaining “good” values are randomly selected and forwarded to the requesting component. Additionally, an “Inconsistent Flag” is asserted and logic within an error correction 140 will attempt to correct the inconsistent memory location with the majority value.

If all three of the volatile memory 60 and the two volatile memory shadows 120, 130 have differing values, a hardware malfunction is declared and the “Hardware Fault” flag is asserted. Higher level hardware and Operating System hardware is assumed to respond appropriately to this fault condition.

The contents of volatile memory 60, 70 are encrypted via processor specific keys and protected by both hardware and Operating System (OS) mechanisms that ensure: (1) Volatile Execute-Only Memory 70 is non-writable except during program loading/swapping operations which are done by a trusted loader and (2) that no code ever executes from Volatile Read/Write/No-Execute Memory 60.

This scheme provides robust operate-through protection against external attacks such as fault injection and as an additional advantage, provides some protection against legitimate hardware faults. In addition, it provides resiliency as it provides a means for corrupted memory to be restored to a “good” state.

At rest, executable code is encrypted. Page-level hashes of executable code are loaded with the OS at boot time for comparison during page loading operations. If hashes differ, an exception is raised and no instructions from the offending page are executed. This “white list” approach proactively prevents malware from ever executing thus protecting critical resources.

Data in motion via system bus 50 is encrypted using symmetric keys from the secure boot process. Data remains confidential even from other trusted devices 10 as encryption keys are source-destination paired. For example, multi-core processor 80←→execute only memory 70, execute only memory 70←→Read/write/no-execute memory 60. This binding implements the secure design principles of separation of privilege, economy of mechanism, and complete mediation with respect to memory operations.

Data is encrypted inside the trusted boundary of multi-core processor 80. Processors 80 are shielded to block electro-magnetic emissions and in multi-processor configurations each processor 80 has distinct cryptographic keys.

Critical security operations such as TPM storage root keys (SRK), signing executables, and loading hash values into the OS images are done within a trusted enclave. In embedded systems, it is expected SRKs are changed for every mission. For other use cases, SRKs should be changed on a periodic basis based on the threat environment.

What is claimed is:

1. An apparatus providing computer system cryptographic protection comprising:
a processor;
a trusted platform module;
trusted bus devices;
a first secure memory and a second secure memory, wherein the first and second memory each have a first and second shadow copy;
an external bus controller; and
a system bus.

2. The apparatus as recited in claim 1 wherein the system bus contains trusted data and connects with the processor, the trusted platform module, trusted bus devices, the first and second secure memory and the external bus controller.

3. The apparatus as recited in claim 1 wherein the external bus controller is connected between the system bus and untrusted external devices.

4. The apparatus as recited in claim 1 wherein data is encrypted when not in use.

5. The apparatus as recited in claim 1 further comprising trust boundaries, wherein encrypted data can be unencrypted within the trust boundary.

6. The apparatus as recited in claim 1 wherein the trusted platform module includes secure key generation, secure key storage and certified and secure multi stage boot services.

7. The apparatus as recited in claim 1 wherein the trusted bus devices are compliant with the trusted platform module and the configuration of the trusted bus devices is verified during secure boot process.

8. The apparatus as recited in claim 1 wherein the first secure memory is a volatile execute only memory and the second secure memory is a volatile read/write/no-execute memory.

9. The apparatus as recited in claim 8 wherein the first secure memory is non writable except during program loading/swapping operations.

10. The apparatus as recited in claim 1 wherein the trusted devices include data at rest, the data at rest being encrypted using secure keys supplied by the trusted platform module.

11. The apparatus as recited in claim 1 wherein the first and second shadow copies of each memory are exact replicas of each of the first and second secure memory.

12. The apparatus as recited in claim 1 wherein the first and second shadow copies are in separate and distinct memory spaces.

13. The apparatus as recited in claim 12 wherein the separate and distinct memory spaces are neither accessible nor addressable by the system bus.

14. The apparatus as recited in claim 1 further comprising a majority function, wherein upon a request, the majority function compares the content of the first shadow copy, the second shadow copy and the related first or second memory component.

15. The apparatus as recited in claim 14 further comprising an error correction unit, wherein if one of the contents of the first shadow copy, second shadow copy and the relevant first or second memory has a differing value, the error correction unit corrects the differing value to match the contents of the other two.

16. The apparatus as recited in claim 1 wherein the trusted devices include data in motion, the data in motion being encrypted by the system bus using symmetric keys from the secure boot process.
